(19) United States
(12) Patent Application Publication
(10) Pub. No.: US 2013/0195573 A1
(43) Pub. Date: Aug. 1, 2013

(54) MACHINE TOOL COMPRISING AN ULTRASONIC SENSOR

(71) Applicant: Christian Podiebrad, Weingarten (DE)

(72) Inventor: Christian Podiebrad, Weingarten (DE)

(21) Appl. No.: 13/879,384

(22) PCT Filed: Oct. 14, 2011
(86) PCT No.: PCT/EP11/05160

§ 371 Date: Apr. 12, 2013

(30) Foreign Application Priority Data
Apr. 19, 2012 (DE) 10-2010-048-303.6

(51) Int. Cl. B23Q 17/20

(52) U.S. Cl. CPC B23Q 17/20
USPC 409/133; 409/64

(57) ABSTRACT

The invention relates to a machine tool having a cutting tool in order to monitor and if necessary to correct the dimensional accuracy of the workpiece during machining. To this end, a sensor (5) for sensing a dimension of the workpiece (10) to be machined during machining is provided.

The invention relates to a machine tool having a cutting tool according to the preamble of claim 1.

In order to machine workpieces by means of cutting tools, for example with the aid of milling tools in what are known as machining centers, the shape of the workpiece to be produced has hitherto been predefined and traversed by a corresponding machine control.

If errors in dimensional accuracy occur afterwards on the machined workpiece, the workpiece cannot be used in the worst case, but at the least complicated reworking has to take place.

It is the object of the invention to reduce or if possible completely to avoid these drawbacks.

Accordingly, a machine tool according to the invention is characterized in that a sensor for sensing a dimension of the workpiece to be machined during machining is provided.

In this way, it is possible to monitor and if necessary to correct the dimensional accuracy of the workpiece during machining.

With the aid of a corresponding control unit, the sensor result can be used to go back to a machined location on the workpiece once again in order to rework the latter if appropriate directly during the production process.

In order to achieve good dimensional accuracy, a machining routine incorporating the sensor data can be constructed, that is to say that the removal of material can take place in two or more steps, with the remaining material thickness always being sensed in between. In this way, the desired material thickness can be achieved accurately with high dimensional accuracy.

In a preferred embodiment of the invention, an ultrasonic sensor is used. It has surprisingly been shown that, with the aid of an ultrasonic sensor, even during the operation of a cutting tool acting in the vicinity of the sensor, reliable and accurate dimension sensing, for example of a material thickness, is possible.

In order to allow good injection of the ultrasonic signal into the material, use is preferably made of a liquid coupling medium which is contact with the ultrasonic sensor on one side, but is in contact with the workpiece on the other side.

Preferably, in the case of the use according to the invention of the ultrasonic sensor in a machine tool, what is known as a cooling lubricant is used as the coupling medium. Cooling lubricant is always in use in cutting machine tools, in particular during milling operations, in order to lubricate and cool both the cutting tools and the workpieces at the site of work.

In a particular embodiment of the invention, the ultrasonic sensor is connected to a nozzle chamber into which the coupling medium is introduced. The nozzle chamber is advantageously provided with an orifice directed onto the workpiece, such that the introduced coupling medium is passed in a targeted manner onto the material to be measured and thus produces contact between the ultrasonic sensor and the workpiece. To this end, in a preferred embodiment of the invention, the nozzle chamber for the coupling medium is provided with a feed line which is connected to the cooling lubricant circuit, present in any case, of the machine.

Advantageously, the sensor device according to the invention is designed to be movable together with the cutting tool with respect to the workpiece to be machined and measured. To this end, it is possible to provide a holder which is connected in a fixed manner to the machining tool. In a particular embodiment of the invention, the holder is attached to a fastening flange of a motor spindle, thereby ensuring that the sensor arrangement is always in a constant position with respect to the cutting tool, for example to a milling tool of a motor spindle.

The nozzle chamber for the coupling medium forms, by way of the described orifice, a nozzle through which the coupling medium is ejected onto the workpiece. In an advantageous development of the invention, this nozzle can have an appropriate shape in order to achieve particular a jet characteristic of the coupling medium.

Various machine tools can be provided according to the invention with a sensor. For example, a milling machine which is used for machining metal sheets, in particular light metal sheets, may be equipped therewith, wherein the sheet thickness at machined locations is returned to if appropriate with the aid of a corresponding control unit and the feedback of the sensor signal.

In a machine tool according to the invention, it is in principle advantageous to provide an in particular controllable or regulatable feed unit for feeding the coupling medium or the cooling lubricant liquid. In this way, it is possible advantageously to control the feed quantity or the stream of liquid or adapt it to the respective situation or machining operation, in order to obtain an as far as possible optimal sensor signal or measuring conditions.

Preferably, the feed unit comprises a feed orifice and/or a feed duct for feeding the coupling medium. In this way, the feeding of the coupling medium can be conducted/guided in a directed or defined manner to a location, to be determined, of the machining operation or of the workpiece to be machined and/or tool. This improves the sensing of the dimension in accordance with the invention.

For example, the feed unit comprises the nozzle chamber and/or the nozzle. Advantageously, the feed duct together with the feed orifice are formed as the nozzle in particular of the nozzle chamber.

In a particular development of the invention, the feed orifice and/or the feed duct is arranged substantially concentrically and/or centrally with respect to the rotation axis of the tool and/or a tool receptacle. As a result, the sensing of the dimension of the workpiece in accordance with the invention can be realized directly at the machining location, in particular virtually in a manner not dependent on the further machining direction of the workpiece, such as milling cutter or the like. This leads to a further improvement in sensing.

Preferably, the sensor is arranged at least partially inside the tool and/or the tool receptacle, for example directly in the center of the tool, or the sensor is arranged substantially concentrically and/or centrally with respect to the rotation axis of the tool and/or of the tool receptacle. By way of this measure, an optimized control characteristic can be ensured. The machine tool can be controlled or regulated in a particularly advantageous manner without great complexity. Thus, it is quite possible in part for the desired or predetermined dimension, according to the invention, of the workpiece to be generated in a single machining cycle/step.

In an advantageous embodiment of the invention, the sensor comprises at least one transmission unit for wireless energy and/or signal transmission. As a result, the transmission of energy and/or sensor signals from the moving or rotating tool/tool receptacle and/or motor spindle components to a stationary or fixed unit, in particular a receiving unit or to the machine control/control unit can be realized in an advantageous manner. Alternatively thereto or in combination therewith, transmission by means of sliding contacts or the like can also be provided.

An exemplary embodiment of the invention is illustrated in the drawing and explained in more detail in the following text by way of the figures.

Specifically, in the drawing:

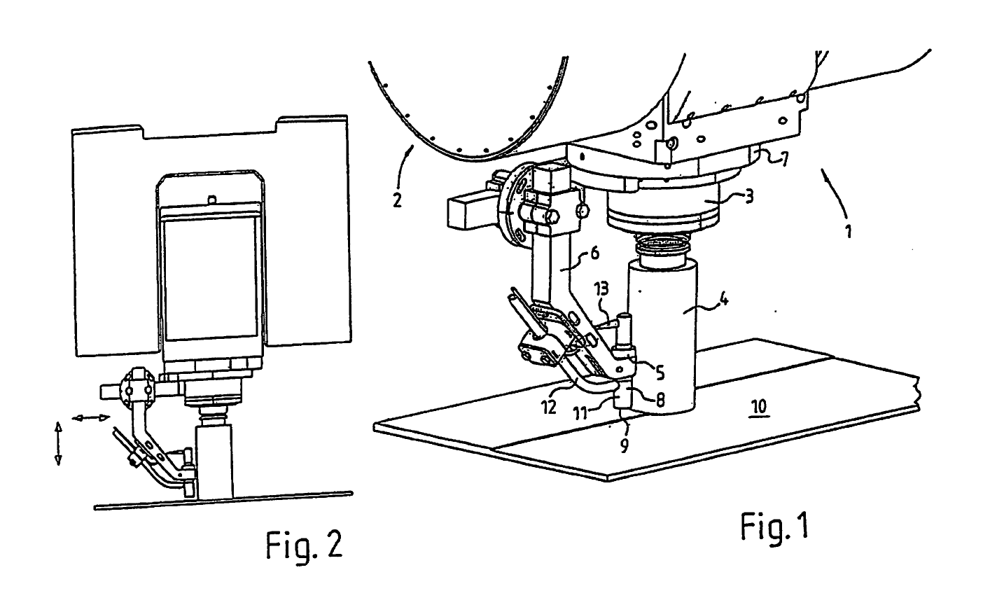

FIG. 1 shows a perspective illustration of a machine tool according to the invention,

FIG. 2 shows a partial illustration of a machine tool according to FIG. 1 in side view, and

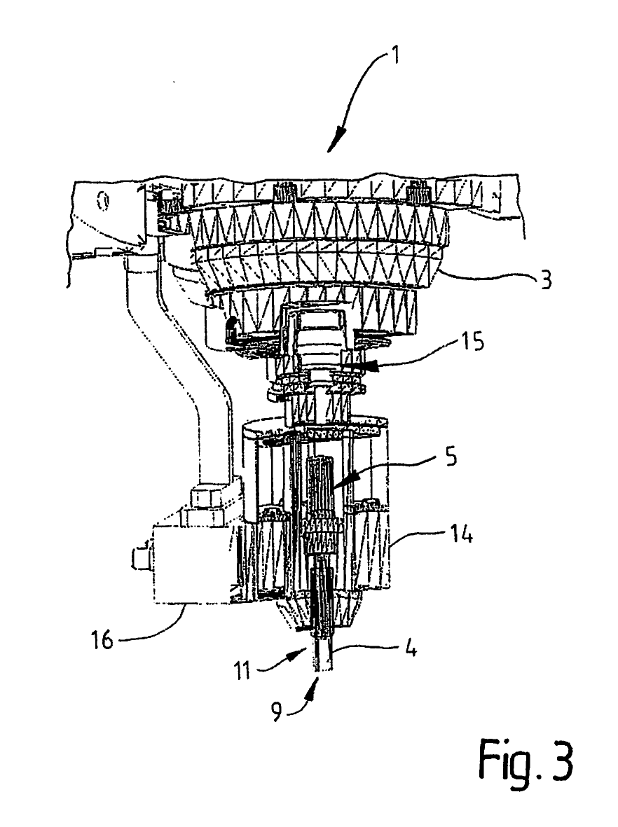

FIG. 3 shows a sectional illustration through a part of a machine tool according to the invention having a sensor arranged centrally in the interior of the tool.

The machine tool 1 according to the invention comprises a milling head 2, by means of which a motor spindle 3 is attached so as to be pivotable about at least one axis and is movable in at least one direction. The milling tool 4 is fixed in the motor spindle 3 and is rotated at a high speed by the latter.

In the present exemplary embodiment, an ultrasonic sensor 5 is fixed in a sensor holder 6. The sensor holder 6 is fixed, for example screwed, on the holder flange 7 of the motor spindle 3.

The ultrasonic sensor 5 is provided with a section of tube 8 which is provided with an orifice 9 which is directed toward the workpiece 10. The section of tube forms together with the orifice 9 a nozzle 11, by means of which a liquid jet of a coupling medium is ejected onto the workpiece 10.

For this purpose, there is provided a feed line 12 which opens into the section of tube 8 and feeds the coupling medium.

As coupling medium, use is preferably made, as stated above, of cooling lubricant from the cooling-lubricant circuit of the machine tool 1. The liquid coupling medium is in this case preferably introduced into the nozzle 11 at such a volume flow that a liquid jet that connects the workpiece 10 to the ultrasonic sensor 5 is formed, thereby allowing both the injection of an ultrasonic signal into the workpiece 10 and the feedback of an ultrasonic signal from the workpiece 10 toward the sensor 5.

The signal from the ultrasonic sensor can be evaluated by way of a control unit, which is not illustrated in more detail and is connected to the ultrasonic sensor 5 via one or more lines 13, and can be used for the further machine control.

In this way, there is quality control for the workpieces 10 as early as during production, and it is also possible, given appropriate control of the machine taking into account the sensor signal, to produce the desired dimensions of the workpiece 10 in a two- or multi-step method, in which the corresponding dimensions are measured in between and subsequently the workpiece is machined again at the desired location. With such a control unit, it is thus possible also to improve the dimensional accuracy of the finished workpieces as a whole.

The machine tool according to the invention affords great advantages in particular in the field of light-metal machining of workpieces with very high quality requirements, for example in aircraft construction or the like, but it can of course also be used elsewhere.

FIG. 3 schematically illustrates a further variant of the invention in section, wherein the sensor 5 is arranged concentrically with the rotation axis and at least partially directly in the interior of the rotation tool 4 or milling cutter 4.

A transmitter 14 is arranged or fixed on the rotating tool 4 or tool receptacle 15, such that said transmitter also rotates during machining. The transmitter 14 transmits or exchanges information or sensor signals and, if appropriate, energy to or with a receiver 16. The receiver 16 is fixed in a stationary or firm manner for example on the stator of a motor spindle or the like and passes the information or sensor signals on to the machine control for processing or control/regulation of the tool 4 in accordance with the invention.

The tool 4 advantageously has a central hole as the duct for the coupling medium or cooling lubricant. As a result, the latter is guided advantageously onto the workpiece 10.

### List of Reference Signs

1 Machine tool
2 Milling head
3 Motor spindle
4 Milling tool
5 Ultrasonic sensor
6 Sensor holder
7 Holder flange
8 Section of tube
9 Orifice
10 Workpiece
11 Nozzle
12 Feed line
13 Line
14 Transmitter
15 Tool receptacle
16 Receiver

1. In a machine tool having a cutting tool wherein the improvement comprises a sensor (5) for sensing a dimension of the workpiece (10) to be machined during machining.

2. The machine tool as claimed in claim 1, characterized in that the sensor is an ultrasonic sensor (5).

3. The machine tool as claimed in claim 2 further comprising a liquid coupling medium for injecting a sensor signal into the workpiece (10).

4. The machine tool as claimed in claim 3 wherein the liquid coupling medium is a cooling lubricant.

5. The machine tool as claimed in claim 1 wherein the cutting tool is a milling tool (4).

6. The machine tool as claimed in claim 1 wherein the dimension sensed by the sensor is a thickness of a metal sheet (10).

7. The machine tool as claimed in claim 2 further comprising a coupling medium and a feed orifice and/or a feed duct for feeding the coupling medium.

8. The machine tool as claimed in claim 7 wherein the feed orifice and/or the feed duct is/are arranged substantially concentrically and/or centrally with respect to the rotation axis of the cutting tool and/or of a tool receptacle.

9. The machine tool as claimed in claim 2 wherein the sensor is arranged at least partially inside the cutting tool and/or a tool receptacle.

10. The machine tool as claimed in claim 2 wherein the sensor is arranged substantially concentrically and/or centrally with respect to the rotation axis of the cutting tool and/or of a tool receptacle.

11. A machine device comprising:
(a) a motor and a device for holding a cutting tool;
(b) a frame support to support said motor and a workpiece base or a workpiece disposed adjacent to said cutting tool;
(c) an ultrasonic sensor disposed on said device for holding a cutting tool or on a cutting tool; and
(d) a nozzle chamber disposed between said cutting tool and said workpiece base or said workpiece to direct one part of a circulating lubricant on said ultrasonic sensor and the other part on said workpiece.

12. The machine device of claim 11 further comprising a liquid coupling medium for injecting a sensor signal into the workpiece.

13. The machine device of claim 12 further comprising a feed orifice disposed on said nozzle chamber.

14. The machine device of claim 11 wherein the ultrasonic sensor is disposed inside a cutting tool.

15. A cutting machine tool comprising:
(a) an ultrasonic sensor disposed on a cutting machine tool;
(b) a workpiece base or workpiece disposed on the cutting machine tool;
(c) a cooling lubricant conduit and nozzle chamber for circulating a liquid coupling medium;
(d) a liquid coupling medium which is in contact on one side with the ultrasonic sensor and on the other side is in contact with the workpiece base or workpiece; and
(e) an orifice in the liquid conduit nozzle chamber directed onto the workpiece base or workpiece.

16. The cutting machine tool of claim 15 wherein the ultrasonic sensor is moveable with the cutting machine tool.

17. The cutting machine tool of claim 15 further comprising a controllable or regulatable feed unit for feeding the liquid coupling medium.

18. The cutting machine tool of claim 15 wherein the ultrasonic sensor is disposed inside the machine cutting tool.

19. The cutting machine tool of claim 15 further comprising a control unit for moving the cutting machine tool.
